(19) United States
(12) Patent Application Publication
(10) Pub. No.: US 2016/0266875 A1
(43) Pub. Date: Sep. 15, 2016

(54) SOFTWARE AUTOMATIC CONFIGURATION APPARATUS, SOFTWARE AUTOMATIC CONFIGURATION METHOD, AND STORAGE MEDIA

(71) Applicant: NEC Corporation, Tokyo (JP)

(72) Inventor: Masashi TAKAHASHI, Tokyo (JP)

(73) Assignee: NEC Corporation

(21) Appl. No.: 15/059,461

(22) Filed: Mar. 3, 2016

(30) Foreign Application Priority Data
Mar. 11, 2015 (JP) 2015-048472

(51) Int. Cl. G06F 9/44

(52) U.S. Cl. CPC G06F 8/20

(57) ABSTRACT

Disclosed is a software automatic configuration apparatus that analyzes software itself to configure software, equipped with functions required by the user, within the analyzed software. The apparatus includes: a memory storing instructions; and at least one processor configured to process the instructions to: extract a depended class from at least two classes belonging to a module comprised in a software program; extract a provided class on which the depended class has a dependency; construct a path of a graph with the module as a vertex, based on a relationship defined from the provided class to the depended class; trace the path of the graph in an opposite direction to add a path in the opposite direction to the graph; and trace the path of the graph added with the path in the opposite direction, using the module as a starting point, to collect a reachable module different from the module.

This application is based upon and claims the benefit of priority from Japanese Patent Application No. 2015-048472, filed on Mar. 11, 2015, the disclosure of which is incorporated herein in its entirety by reference.

### TECHNICAL FIELD

The present invention relates to a technique for automatically configuring software from a set of modules for configuring software.

### BACKGROUND ART

Java (registered trademark; the same is true hereinafter) EE (old name: J2EE) that is a standard specification for an application server is provided with an additional function upon every version upgrade. Even when only some functions in Java_EE are desired to be used, an application server incorporating all functions needs to be executed, resulting in poor execution efficiency. To achieve a lightweight application server, the concept of a profile is introduced from the Java_EE_6 version. By this profile introduction, in Java_EE_6, the “full profile” is available when all functions are desired to be used and the lightweight, “Web profile” is available when functions limited to a Web application are desired to be used. An application server based on Java_EE may provide a unique profile.

Creating a profile for a certain piece of software, means extracting a subset sufficient to implement some required functions from a set of modules for implementing all functions of the certain piece of software. The vendor of the certain piece of software may regularly provide a profile or the user may personally create a profile.

To create a subset of reduced-model software capable of implementing only some of all functions built into a certain piece of software, a set of modules required to implement some functions need only be extracted from a set of modules for implementing all functions.

However, when reduced-model software is to be configured by a user who uses a certain piece of software, it is generally difficult to extract appropriate modules. This is because the user needs knowledge equivalent to software designer's knowledge, including an understanding of details of module functions, determination of the dependencies between modules, and the like. It is, therefore, impractical to extract modules by the user.

PTL 1 (Japanese Unexamined Patent Application Publication No. 2009-205190) discloses a technique for extracting a set of modules using a database related to a combination of modules, independently of a target piece of software.

PTL 2 (Japanese Unexamined Patent Application Publication No. 2013-69086) discloses a technique for collecting modules by resolving the dependencies.

PTL 3 (Japanese Unexamined Patent Application Publication No. 2008-242873) discloses a technique for extracting a set of modules using a tree-structured database.

In PTL 1, to extract the set of modules, a database related to a combination of modules is used independently of the target piece of software. In other words, it is necessary not only to provide the target piece of software but also to separately provide auxiliary information. Since, however, the software vendor does not publish such auxiliary information and the user keeps only software codes at hand, it is practically impossible for the user to extract modules.

In PTL 2, modules are collected by resolving the dependencies. However, when interfaces are separated from implementations, the modules are loosely coupled with each other. This poses a problem: simply tracking the dependencies is insufficient to list modules sufficient to implement required functions.

In PTL 3, software itself is not analyzed and a separate database is necessary. This poses a problem: extracting a set of modules using the database requires an existing tree-structured database.

The present invention has been made in order to solve the above-mentioned problems. It is a main object of the present invention to analyze software itself to configure software, equipped with functions required by the user, within the analyzed software.

### SUMMARY

An aspect of the disclosed is

A software automatic configuration apparatus including:

a memory storing instructions; and

at least one processor configured to process the instructions to:

extract a depended class from at least two classes belonging to a module comprised in a software program;

extract a provided class on which the depended class has a dependency;

construct a path of a graph with the module as a vertex, based on a relationship defined from the provided class to the depended class;

trace the path of the graph in an opposite direction to add a path in the opposite direction to the graph; and

trace the path of the graph added with the path in the opposite direction, using the module as a starting point, to collect a reachable module different from the module.

Another aspect of the disclosed is

A software automatic configuration method including:

extracting a depended class from at least two classes belonging to a module comprised in a software program;

extracting a provided class on which the depended class has a dependency;

constructing a path of a graph with the module as a vertex, based on a relationship defined from the provided class to the depended class;

tracing the path of the graph in an opposite direction to add a path in the opposite direction to the graph; and

tracing the path of the graph added with the path in the opposite direction, using the module as a starting point, to collect a reachable module different from the module.

Another aspect of the disclosed is a non-transitory computer-readable recording medium storing a software automatic configuration program for causing a computer to execute the functions of:

extracting a depended class from at least two classes belonging to a module comprised in a software program;

extracting a provided class on which the depended class has a dependency;

constructing a path of a graph with the module as a vertex, based on a relationship defined from the provided class to the depended class;

tracing the path of the graph in an opposite direction to add a path in the opposite direction to the graph; and

tracing the path of the graph added with the path in the opposite direction, using the module as a starting point, to collect a reachable module different from the module.

The present invention makes it possible to analyze software itself to configure software, equipped with functions required by the user, within the analyzed software.

### BRIEF DESCRIPTION OF THE DRAWINGS

Exemplary features and advantages of the present invention will become apparent from the following detailed description when taken with the accompanying drawings in which:

FIG. 1 is a block diagram illustrating an exemplary hardware configuration of a software automatic configuration apparatus according to a first exemplary embodiment of the present invention;

FIG. 2 is a block diagram illustrating an exemplary configuration including software for the software automatic configuration apparatus according to the first exemplary embodiment of the present invention;

FIG. 3 is a view illustrating the data structure of an input module group in a permanent storage device;

FIG. 4 is a view illustrating an exemplary standard format for a class file;

FIG. 5 is a flowchart illustrating the operation of a starting unit;

FIG. 6 is a diagram illustrating data within a module list storage unit;

FIG. 7 is a flowchart illustrating the operation of a provided class extraction unit;

FIG. 8 is a table illustrating the data content of a graph table at the time of the completion of provided class extraction unit processing;

FIG. 9 is a flowchart illustrating the operation of a depended class extraction unit;

FIG. 10 is a conceptual view depicting the relationship between the class file and the memory structure;

FIG. 11 is a flowchart illustrating the operation of a relationship extraction unit;

FIG. 12 is a table illustrating the data content of a graph table at the time of the completion of processing by the relationship extraction unit;

FIG. 13 is a flowchart illustrating the operation of a graph construction unit;

FIG. 14 is a table illustrating the data content of a graph table at the time of the completion of processing by the graph construction unit;

FIG. 15 is a graph diagram representing the dependencies between modules;

FIG. 16 is a flowchart illustrating the operation of a dereference construction unit;

FIG. 17 is a table illustrating the data content of a graph table at the time of the completion of processing by the dereference construction unit;

FIG. 18 is a graph diagram representing the dependencies between modules;

FIG. 19 is a flowchart illustrating the operation of a module collection unit;

FIG. 20 is a flowchart illustrating a graph search operation by the module collection unit;

FIG. 21 is a table illustrating the data content of an output module group within the permanent storage device at the end of the operation of the module collection unit;

FIG. 22 is a graph diagram representing the dependencies of the output module group within the permanent storage device at the end of the operation of the module collection unit; and

FIG. 23 is a block diagram illustrating an exemplary configuration of a software automatic configuration apparatus according to a second exemplary embodiment of the present invention.

FIG. 24 is a block diagram illustrating an exemplary configuration of an information processing apparatus.

### EXEMPLARY EMBODIMENT

Next, a detailed explanation will be given for exemplary embodiments with reference to the drawings. In the following description of the drawings, the same or similar reference numerals denote the same or similar parts. Note, however, that the drawings schematically illustrate configurations in exemplary embodiments of the present invention. The following exemplary embodiments of the present invention are merely examples and can be changed as appropriate within the scope of their equivalents.

### First Exemplary Embodiment

### (Software Automatic Configuration Apparatus)

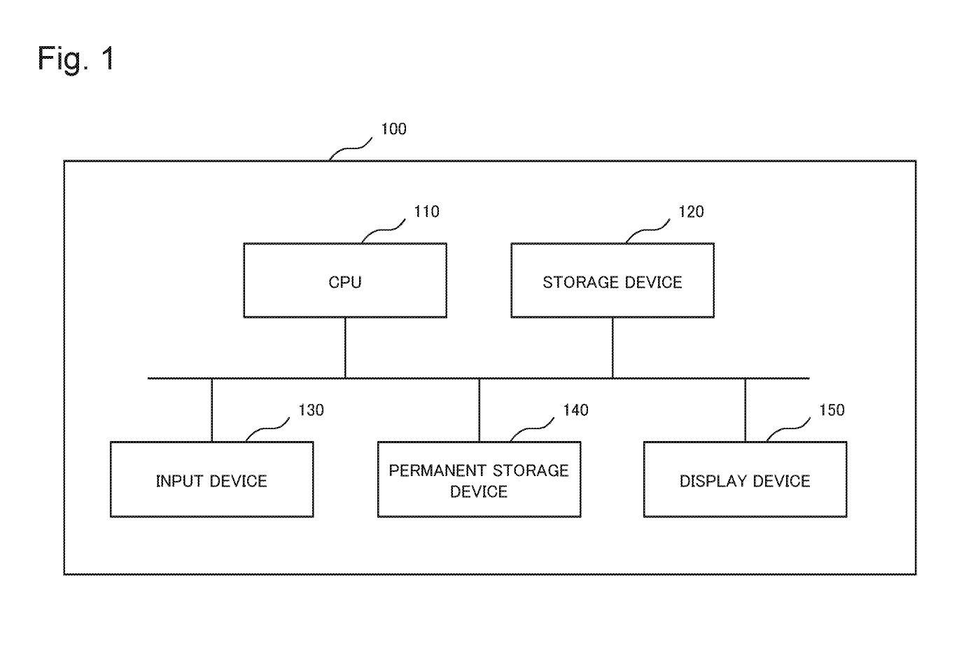

FIG. 1 illustrates an example of an information processing apparatus 100 which constitutes the hardware of a software automatic configuration apparatus according to a first exemplary embodiment of the present invention. The information processing apparatus 100 includes a CPU (Central Processing Unit) 110, a storage device 120, an input device 130, a permanent storage device 140, and a display device 150.

The storage device 120 serves as a memory which stores data and programs executed by the CPU 110 and includes, for example, a ROM (Read Only Memory) and a RAM (Random Access Memory).

The input device 130 presents selectable functions to a user and accepts the result of selection by the user (that is, a list of functions selected by the user). The input device 130 includes, for example, a touch panel, a keyboard, a mouse, and an input button. Details of how to define and manage selectable modules are defined independently of the present invention.

The permanent storage device 140 serves as a memory which stores data input to and output from the present apparatus and is implemented in, for example, a permanent storage. The permanent storage device 140 stores data used across sessions in a specific domain, for file management in the computer, input to and output from an external storage device (not illustrated), and the like. The permanent storage device 140 stores not only currently available instances associated with itself but also currently unavailable instances. This allows the reuse of predetermined instances.

The display device 150 displays the processes of the present apparatus and the processing results obtained by this apparatus to allow the user to recognize them. The display device 150 is implemented in, for example, a liquid crystal display panel and may serve as a tablet terminal or the like integrated with the input device 130.

The CPU 110 loads programs from the storage device 120 and executes them, as appropriate. The CPU 110 itself may be equipped with such programs as an electronic circuit. The CPU 110 reads data from the permanent storage device 140, automatically configures software for implementing a function specified by the input device 130, and outputs a result to the permanent storage device 140 and the display device 150.

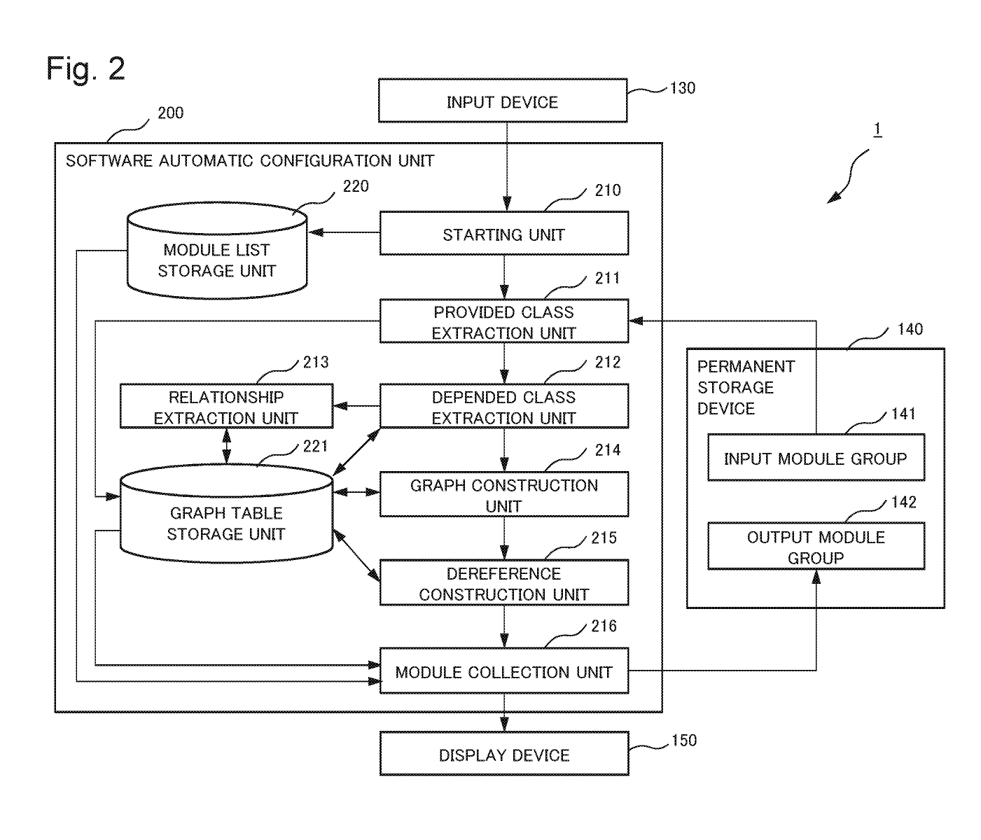

FIG. 2 is a block diagram illustrating an exemplary configuration of a software automatic configuration apparatus 1 according to the first exemplary embodiment of the present invention. FIG. 2 corresponds to the information processing apparatus 100 illustrated in FIG. 1. The software automatic configuration apparatus 1 includes a software automatic configuration unit 200, an input device 130, a permanent storage device 140, and a display device 150.

The software automatic configuration unit 200 includes a starting unit 210, a provided class extraction unit 211, a depended class extraction unit 212, a relationship extraction unit 213, a graph construction unit 214, a dereference construction unit 215, a module collection unit 216, a module list storage unit 220, and a graph table storage unit 221. Each module is used for a software program which provides a specific function to the user.

The starting unit 210 receives from the input device 130, a list of module names corresponding to functions selected by the user and records the received list of module names in the module list storage unit 220. The list of module names will also be referred to as a module list hereinafter.

The provided class extraction unit 211 reads an input module group 141 stored in the permanent storage device 140, generates a list of classes provided by each read module (provided classes), and records the generated list in the graph table storage unit 221.

The depended class extraction unit 212 scans the graph table storage unit 221 and sequentially analyzes the provided classes to extract depended classes. The depended class extraction unit 212 records the extraction result in the graph table storage unit 221. The depended classes mean classes that depend on the provided classes and are influenced by changes in details of the provided classes.

The relationship extraction unit 213 analyzes the inheritance relationship between the classes based on the relationship between the provided class and the depended class to check whether the provided class and the depended class have the “is-a” relationship between them, and writes the check result into the graph table storage unit 221. The “is-a” relationship means that one class A and another class B have an inheritance relationship between them. More specifically, the “is-a” relationship means that class A “is a” class B, i.e., class A is one type of class B.

The graph construction unit 214 constructs a graph representing modules as vertices, using directed edges on the basis of the provided classes and the depended classes stored in the graph table storage unit 221.

The dereference construction unit 215 refers to the graph table storage unit 221 to introduce directed edges in the direction opposite to the directed edges of the graph constructed by the graph construction unit 214, for the classes having the “is-a” relationship, and writes the introduction result into the graph table storage unit 221.

The module collection unit 216 traces the graph of modules represented by the graph table storage unit 221, using module names recorded in the module list storage unit 220 as starting points, to collect reachable modules. The module collection unit 216 records the collected modules in the permanent storage device 140 as an output module group 142. The module collection unit 216 outputs the processing result to the display device 150.

The module list storage unit 220 stores a list of modules as a list of module names input from the input device 130.

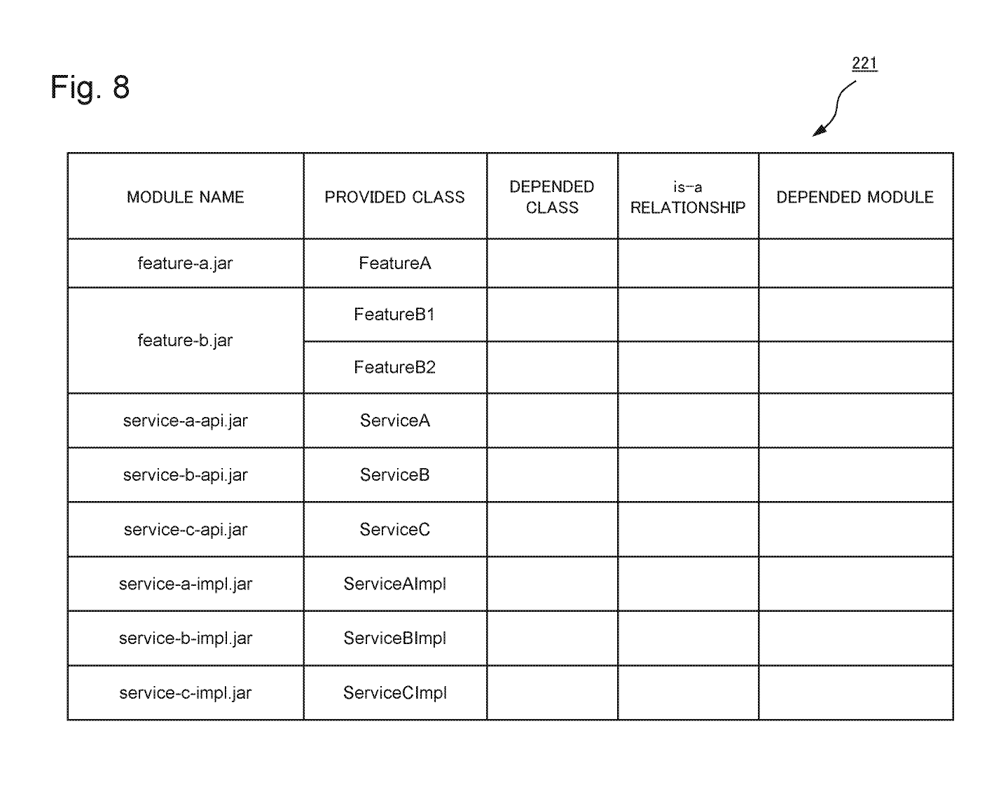

The graph table storage unit 221 stores a graph table (a table in a format illustrated in FIG. 8; to be described later) into which an intermediate result that occurs in the process of the software automatic configuration unit 200 is to be written. The graph table finally serves as data for constructing a digraph which represents the dependencies between modules.

Respective units (the starting unit 210, the provided class extraction unit 211, the depended class extraction unit 212, the relationship extraction unit 213, the graph construction unit 214, the dereference construction unit 215, and the module collection unit 216) within the software automatic configuration unit 200 illustrated in FIG. 2 can be interpreted as programs represented for each functional block. These programs are stored in a ROM, a RAM, or the like in the CPU 110 or the storage device 120 illustrated in FIG. 1. The CPU 110 runs these programs for arithmetic operations as appropriate to execute these functions. The above-described respective units may be implemented in hardware such as an electronic circuit. The storage device 120 illustrated in FIG. 1 includes the module list storage unit 220 and the graph table storage unit 221.

The permanent storage device 140 stores the input module group 141 and the output module group 142. The input module group 141 is a module group for software programs that are data input to the software automatic configuration apparatus 1. The output module group 142 is a module group for software programs that are data output from the software automatic configuration apparatus 1.

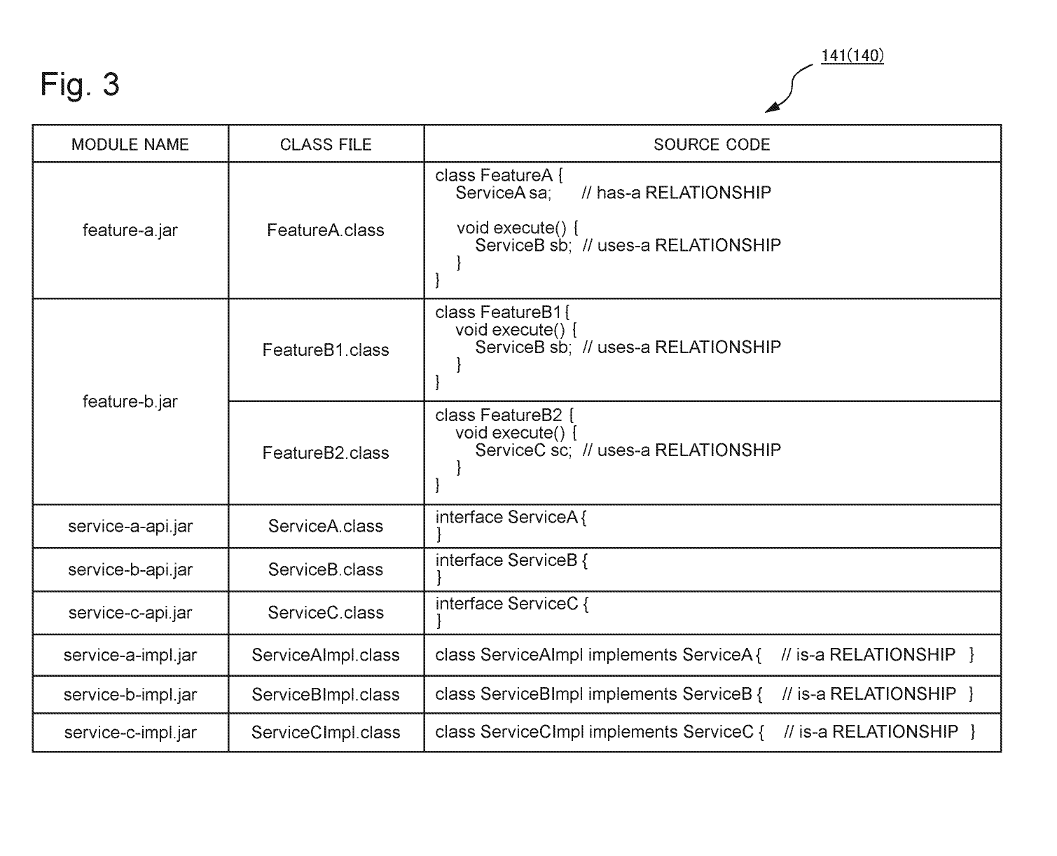

FIG. 3 illustrates an example of the input module group 141. The input module group 141 forms a data set including, as items, module names, class files, and source code corresponding to the class files. Each row of the input module group 141 illustrated in FIG. 3 shows one module (one module record).

Modules are represented in archive files called Jar files in Java, and module names indicate the archive file names. The modules include class files as the result of compilation of source code. The modules may also include, for example, manifest files representing metadata for the modules. The input module group 141 illustrated in FIG. 3 includes modules on eight rows, that is, eight software programs, and each module holds a class file and source code corresponding to the class file. Referring to FIG. 3, the “source code” represents the state before compiling the “class file” and is not included in the Jar file.

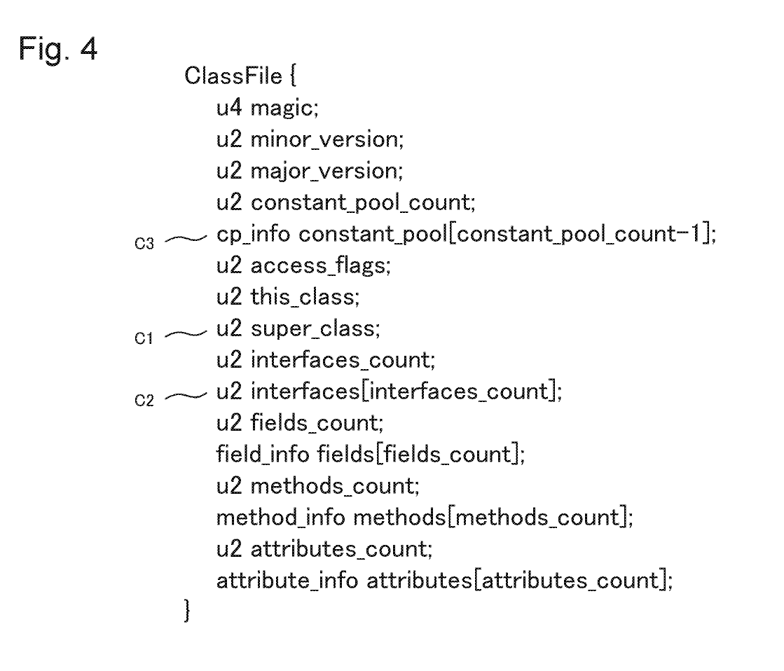

FIG. 4 is a view illustrating an exemplary format for a class file (ClassFile). A standard format for a class file is defined in “The Java Virtual Machine Specification” (the latest version at the time of filing: Java_SE_8_Edition, issued on Mar. 3, 2014). In the class file illustrated in FIG. 4, “constant pool (C3)” contains all pieces of detailed information concerning the class. An index indicating where the detailed information of the class is stored in constant_pool (C3) is stored in “super_class (C1).” An index indicating where the detailed information of an interface is stored in constant_pool (C3) is stored in “interfaces (C2).”

All pieces of information stated in the “source code” of the input module group 141 illustrated in FIG. 3 are converted into class files. In other words, it may be assumed that the dependencies between the classes presented in the “source code” can be easily obtained from the compiled class files. The subsequent description is based on this assumption.

### (Operation of Software Automatic Configuration Apparatus)

An operation for automatically configuring a Java application will be described below as an exemplary operation of the software automatic configuration apparatus 1 according to the first exemplary embodiment of the present invention.

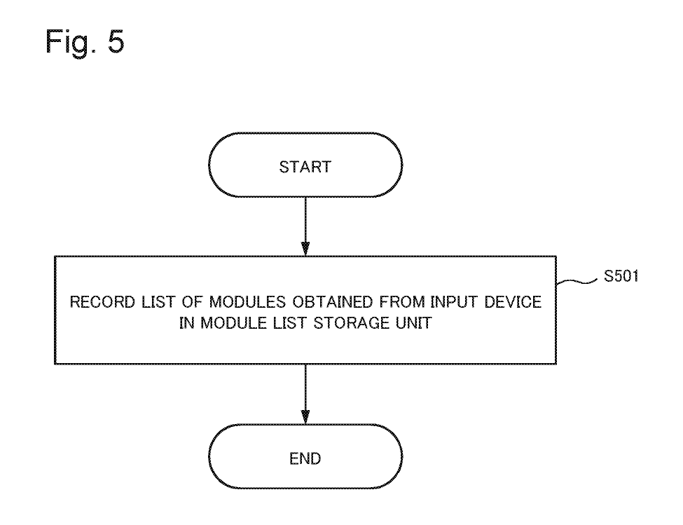

The operation of the starting unit 210 will be described first with reference to FIG. 5.

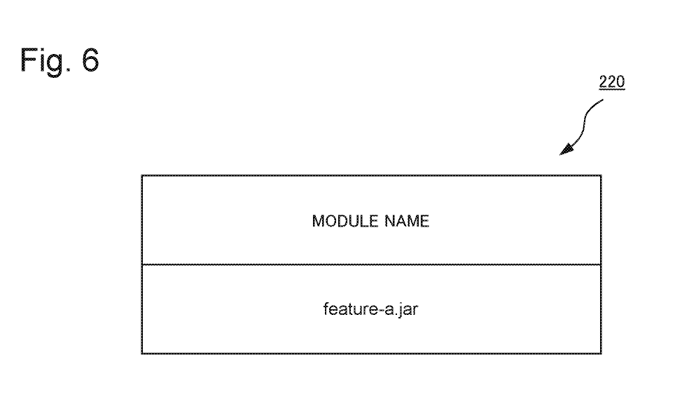

In step S501, the user of the software automatic configuration apparatus 1 uses the input device 130 such as a keyboard and a mouse to specify, a module name corresponding to a function that the user wants to directly use, in the starting unit 210. Assuming, as an example, that the user has specified a module specified by the module name “feature-a.jar” illustrated in FIG. 3 as a function desired to be used, the subsequent operation will be described hereinafter. Upon receiving the specified information, the starting unit 210 records a module list received from the input device 130 in the module list storage unit 220. In this case, feature-a.jar is recorded in the module list storage unit 220, as illustrated in FIG. 6. With the aforementioned procedure, the starting unit 210 ends its operation. Referring to FIG. 6, although only one module name is recorded in the module list storage unit 220, a plurality of module names may be present.

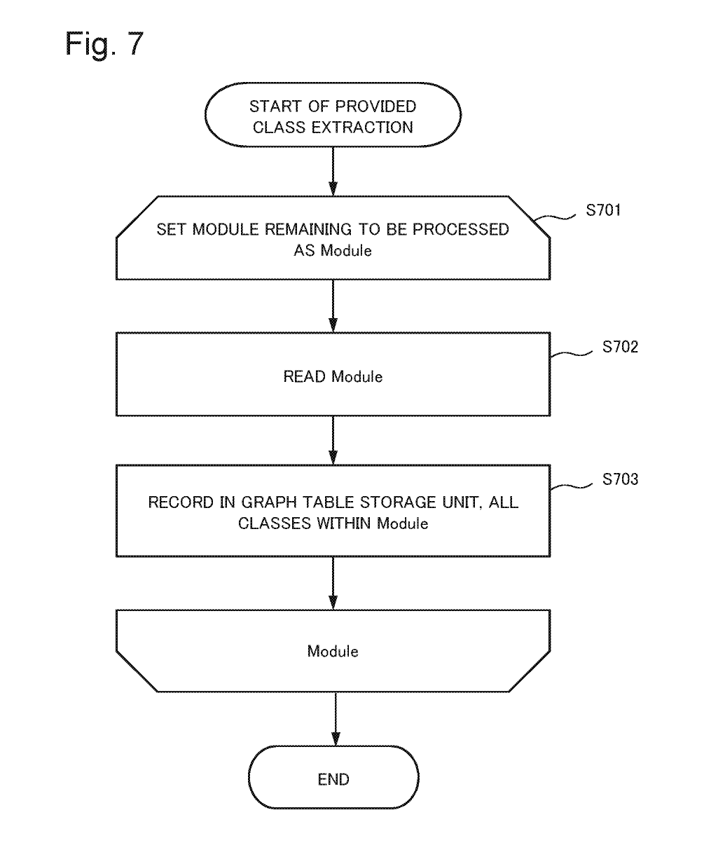

After the end of the operation of the starting unit 210, the provided class extraction unit 211 starts its operation. The operation of the provided class extraction unit 211 will be described below with reference to a flowchart illustrated in FIG. 7.

In step S701, the provided class extraction unit 211 sets a module remaining to undergo class extraction processing in the input module group 141 (see FIG. 3) as “Module” (field name: the variable name of a data storage area). The provided class extraction unit 211 executes processes in steps S702 and S703 while any module remains to be processed.

In step S702, the provided class extraction unit 211 reads the content of “Module” (modules).

In step S703, the provided class extraction unit 211 extracts classes held in “Module” (provided classes) and records the extracted classes in the graph table storage unit 221 for each module name (see FIG. 8).

When all modules have been processed, the provided class extraction unit 211 ends its operation.

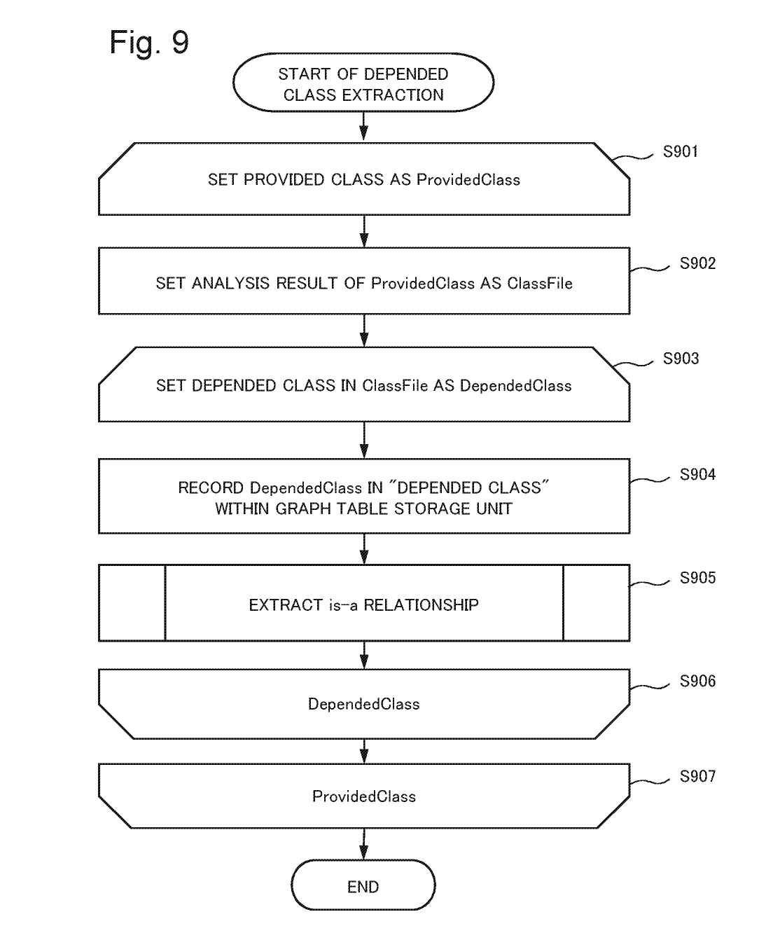

After the end of the operation of the provided class extraction unit 211, the depended class extraction unit 212 starts its operation. The operation of the depended class extraction unit 212 will be described below with reference to a flowchart illustrated in FIG. 9.

In step S901, the depended class extraction unit 212 sets the “provided class” stored in the graph table storage unit 221 (see FIG. 8) as ProvidedClass (variable name). The loop including steps S901 through S907 is iterated while any class in ProvidedClass remains to be processed.

In step S902, the depended class extraction unit 212 analyzes ProvidedClass and sets each value obtained by analysis in the ClassFile format illustrated in FIG. 4.

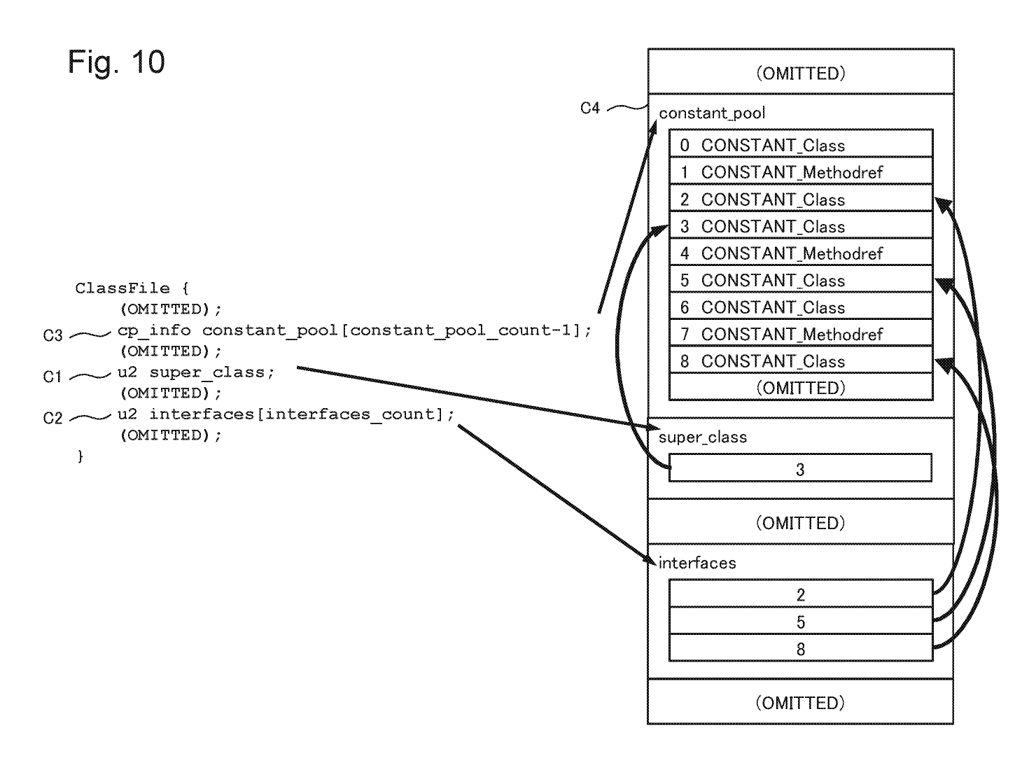

In step S903, the depended class extraction unit 212 extracts the depended class held in ClassFile and sets it as DependedClass (variable name). Extraction processing will be described below with reference to FIG. 10. FIG. 10 is a view depicting the relationship between the class file and the memory structure. The memory means the storage device 120 for class files, or the like. An index indicating where all pieces of detailed information concerning the class are located is stored in constant pool (C3) illustrated in FIG. 10. A memory C4 for constant pool associated with the index stores, for example, “CONSTANT_Class” and “CONSTANT_Methodref.” CONSTANT_Class represents the detailed information of a class. CONSTANT_Methodref represents the detailed information of a method. Each piece of information in CONSTANT_Class located in the memory C4 represents a class required by a class related to ClassFile, that is, a depended class for the provided class. The depended class extraction unit 212 extracts the index from constant_pool (C3) within ClassFile illustrated in FIG. 10 and further extracts CONSTANT_Class (depended class) held in the constant pool memory C4 specified by the index. The depended class extraction unit 212 sets the extracted depended class as DependedClass (variable name).

The loop including steps S903 through S906 is iterated while any class in DependedClass remains to be processed.

In step S904, the depended class extraction unit 212 records the information of DependedClass in the depended class (see FIG. 8) within the graph table storage unit 221.

In step S905, the depended class extraction unit 212 invokes the relationship extraction unit 213 to have it execute relationship extraction processing. This process will be described in more detail later.

Upon the completion of processing of the loop including steps S901 through S907 and the loop including steps S903 through S906, the depended class extraction unit 212 ends its operation.

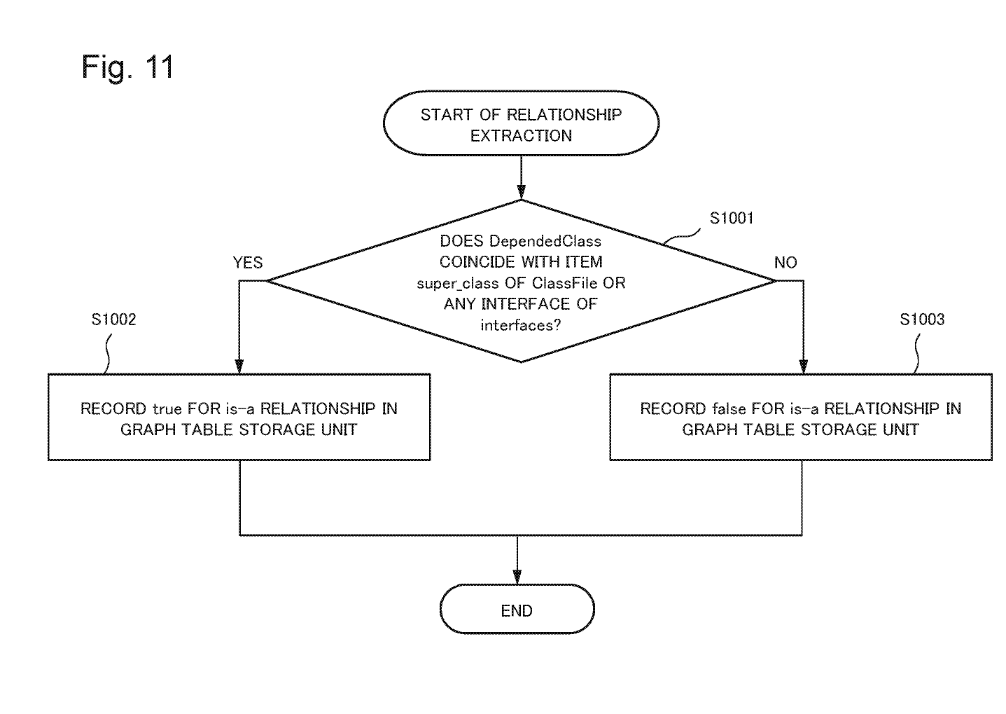

In the process of the depended class extraction unit 212, the relationship extraction unit 213 is invoked and executes its extraction operation. The operation of the relationship extraction unit 213 will be described below with reference to a flowchart illustrated in FIG. 11.

In step S1001, the relationship extraction unit 213 receives ClassFile and DependedClass from the depended class extraction unit 212. For received ClassFile and DependedClass, the relationship extraction unit 213 refers to the ClassFile format illustrated in FIG. 4 and determines condition 1): whether DependedClass coincides with a super class specified in the item super class (C1) within ClassFile; or condition 2): whether DependedClass coincides with any interface of an interface group specified in the item “interfaces” within ClassFile.

A determination operation will be described below with reference to FIG. 10. An index indicating where all pieces of detailed information concerning the class are located is stored in “constant_pool (C3),” as illustrated in FIG. 10. An index where the detailed information of a class is stored in constant_pool (C3) is stored in “super_class (C1).” An index indicating where the detailed information of an interface is stored in constant_pool (C3) is stored in “interfaces (C2).”

The relationship extraction unit 213 determines based on condition 1), whether DependedClass is included in the detailed information of a class within constant_pool that can be indirectly referred to using the index stored in super_class (C1).

The relationship extraction unit 213 further determines based on condition 2), whether DependedClass is included in the detailed information of an interface within constant_pool that can be indirectly referred to using the index stored in “interfaces (C2).”

In general, for class type variables, it is possible to substitute not only an object generated from a provided class but also an object generated from a depended class. For interface type objects, it is possible to substitute an object generated from an implemented class. In other words, both the inheritance of a super class and the implementation of an interface have the “is-a” relationship.

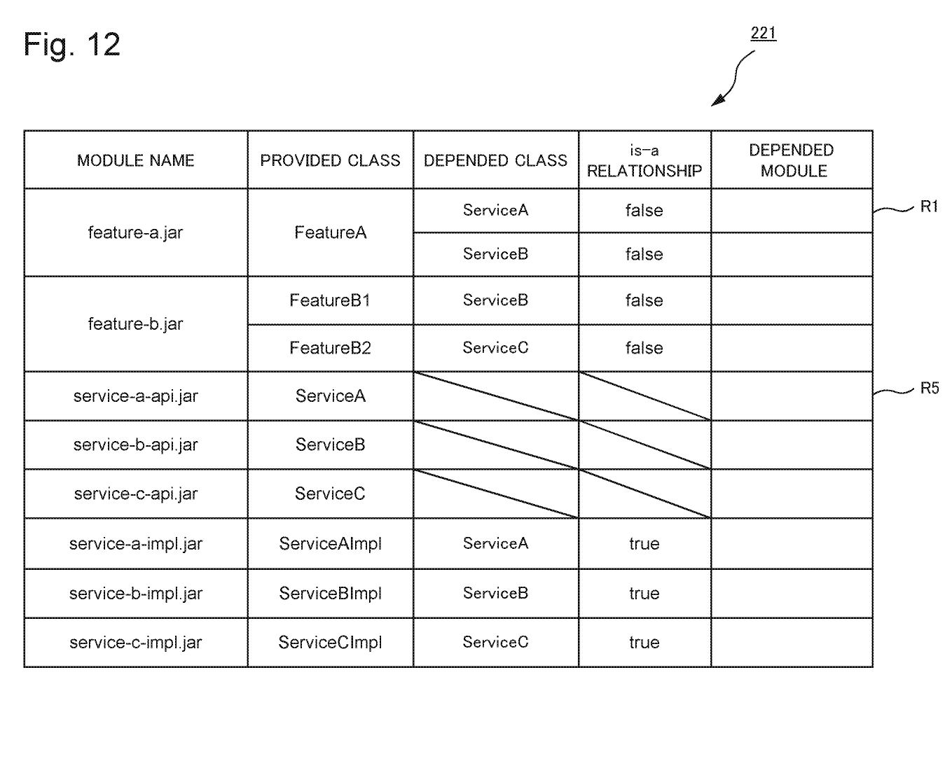

If it is determined in step S1001 that at least one of conditions 1) and 2) holds true, the process advances to step S1002. In step S1002, the relationship extraction unit 213 records “true” in the “is-a” relationship item within the graph table storage unit 221 (see FIG. 12). In graph reconstruction, three types of dependencies: “is-a (inheritance),” “has-a (inclusion),” and “uses-a (use)” exist in object-oriented design. In the present exemplary embodiment, an “is-a (inheritance)” relationship is extracted from the dependencies between interfaces and edges in the direction opposite to this relationship are introduced to reconstruct a graph representing the dependencies.

If it is determined in step S1001 that neither condition 1) nor 2) holds “true”, the process advances to step S1003. In step S1003, the relationship extraction unit 213 records “false” in the “is-a” relationship item within the graph table storage unit 221.

With the aforementioned procedure, the relationship extraction unit 213 ends its operation, and the process returns to the depended class extraction unit 212 again.

When the depended class extraction unit 212 completes its operation, the relationship extraction unit 213 invoked from the depended class extraction unit 212 also completes its operation. At this point in time, the graph table in the graph table storage unit 221 is recorded in the form as illustrated in FIG. 11. The depended class item data, as illustrated in FIG. 11, is information recorded by processing in the depended class extraction unit 212. The “is-a relationship” item data is information recorded by processing in the relationship extraction unit 213. Boxes marked with diagonal lines in FIG. 12 indicate the absence of relevant information.

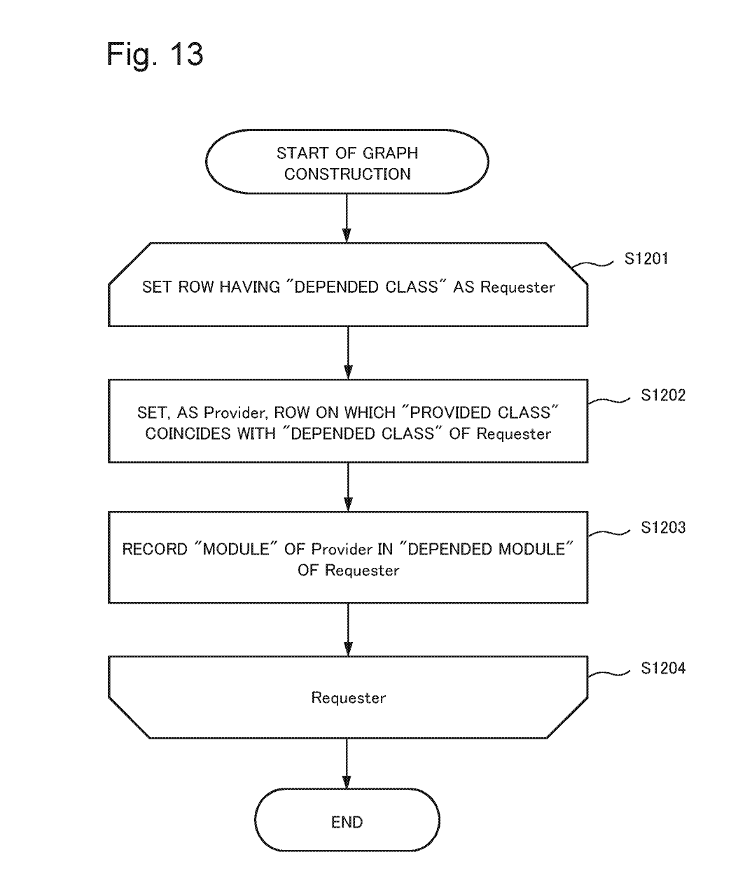

After the end of the operation of the depended class extraction unit 212, the graph construction unit 214 starts its operation. A processing operation in the graph construction unit 214 will be described below with reference to a flowchart illustrated in FIG. 13.

In step S1201, the graph construction unit 214 sets, as a Requester (request side) row, a row on which the “depended class” item has a record in the graph table (see FIG. 12) within the graph table storage unit 221. The loop including steps S1201 through S1204 is iterated while any Requester row remains to be processed.

In step S1202, the graph construction unit 214 obtains a row on which the provided class item in the graph table within the graph table storage unit 221 coincides with the depended class item on the Requester row, and sets the obtained row as a Provider (providing side) row.

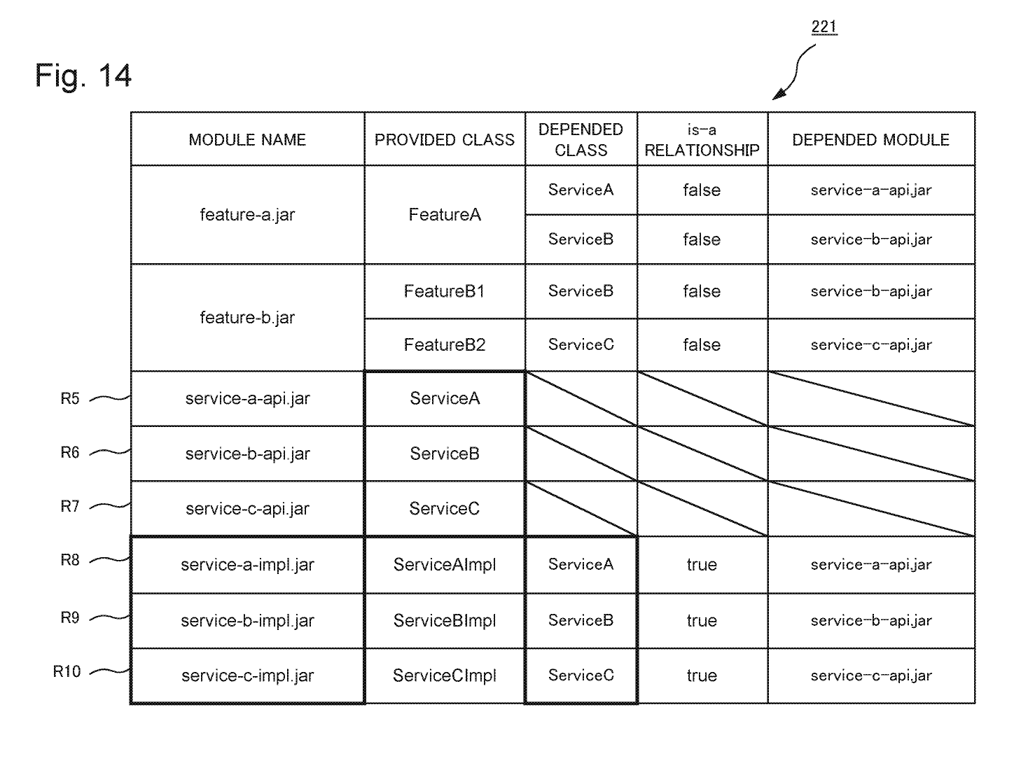

In step S1203, the graph construction unit 214 records the data held in the module item on the Provider row, in the depended module item on the Requester row, in the graph table within the graph table storage unit 221 (see FIG. 14).

For example, the depended class item data of record R1 on the first row from the top illustrated in FIG. 12 is Service A. Record R5 on the fifth row stores Service A in the provided class item. The module item data of record R5 is “service-a-api.jar,” which is recorded in the depended module item of record R1.

Upon the completion of processing of the loop including steps S1201 through S1204, the graph construction unit 214 ends its operation.

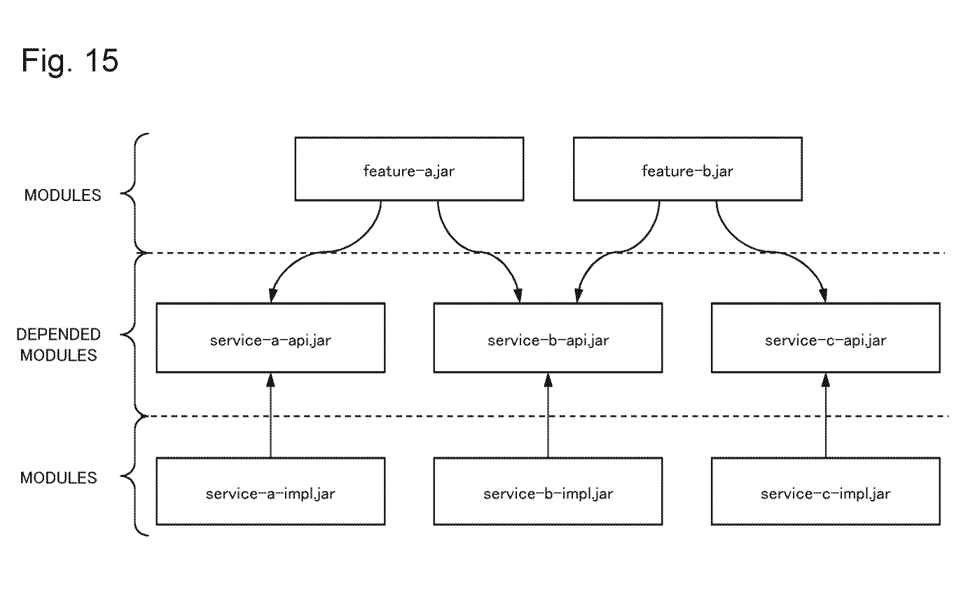

At the end of graph construction processing in the graph construction unit 214, the graph table storage unit 221 contains data as depicted in FIG. 14. The graph table illustrated in FIG. 14 represents the state before introducing directed edges in the direction opposite to the is-a relationship, as a feature of the present exemplary embodiment. To foster a better understanding, a graph showing the concept of the dependencies between modules, based on the graph table shown in FIG. 14, is illustrated in FIG. 15. The graph illustrated in FIG. 15 is represented using directed edges with “modules” as starting points and “depended modules” as endpoints. This graph (digraph) shows the state (structure) in which respective modules located on the upper and lower sides of the central, depended modules (service-a-api.jar, service-b-api.jar, and service-c-api.jar) that are horizontally aligned at the center and operate as interfaces are loosely coupled with each other.

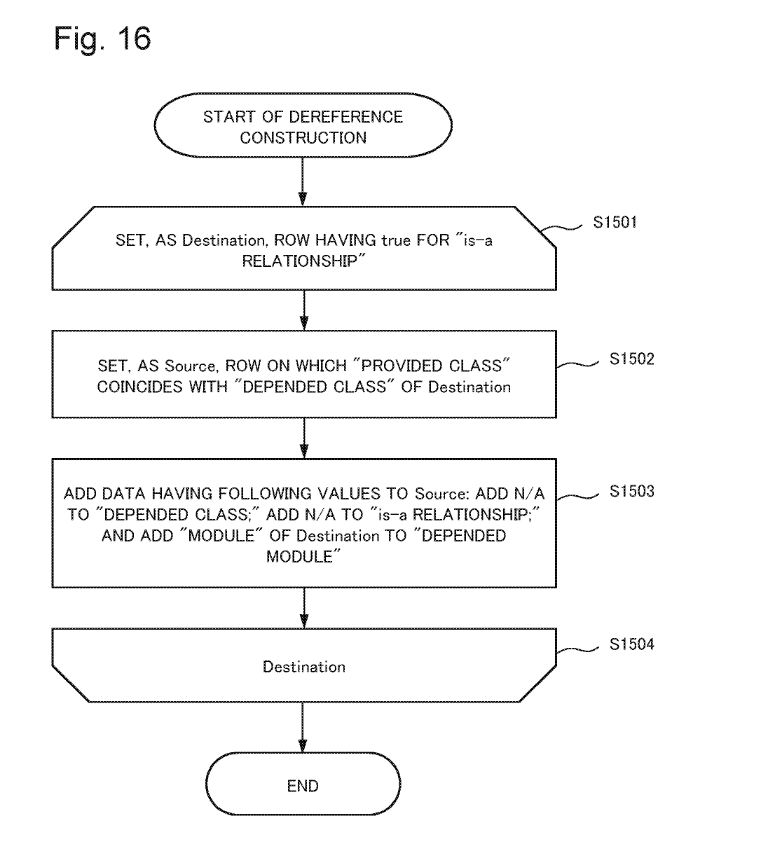

After the end of the operation of the graph construction unit 214, the dereference construction unit 215 starts its operation. A processing operation in the dereference construction unit 215 will be described below with reference to a flowchart illustrated in FIG. 16.

In step S1501, the dereference construction unit 215 sets, as a Destination (destination) row, a row on which the is-a relationship item data is true in the graph table within the graph table storage unit 221. More specifically, for the graph table illustrated in FIG. 14, the dereference construction unit 215 sets records R8, R9, and R10 on the eighth to 10th rows from the top as Destination rows. After recording, the loop including steps S1501 through S1504 is iterated while any Destination row in the graph table remains to be processed.

In step S1502, the dereference construction unit 215 obtains a row on which the provided class item in the graph table within the graph table storage unit 221 coincides with the depended class item on the Destination row, and sets the obtained row as a Source (source) row.

In step S1503, the dereference construction unit 215 adds the following values (or data) to the Source row: N/A (Not Available: no value being set) is added to the “depended class” item; N/A is added to the “is-a relationship” item; and the “module” item on the Destination row is added to the “depended module” item.

This operation will be described in more detail below. “service A”, “service B”, and “service C” are stored as depended class item data in records R8, R9, and R10, respectively, on Destination rows illustrated in FIG. 14. Records R5, R6, and R7 include these types of data as provided class item data. Records R5, R6, and R7 are set on Source rows and predetermined data is recorded in the above-mentioned depended class item, is-a relationship item, and depended module item in records R5, R6, and R7. In recording the depended module item, data (service-a-impl.jar, service-b-impl.jar, and service-c-impl.jar) held in the module item on respective Destination rows (R8, R9, and R10) are recorded as depended module item data, on rows (R5, R6, and R7) having provided class item data that are identical to the depended class item data on the Destination rows.

Upon the completion of processing of the loop including steps S1501 through S1504, the dereference construction unit 215 ends its operation.

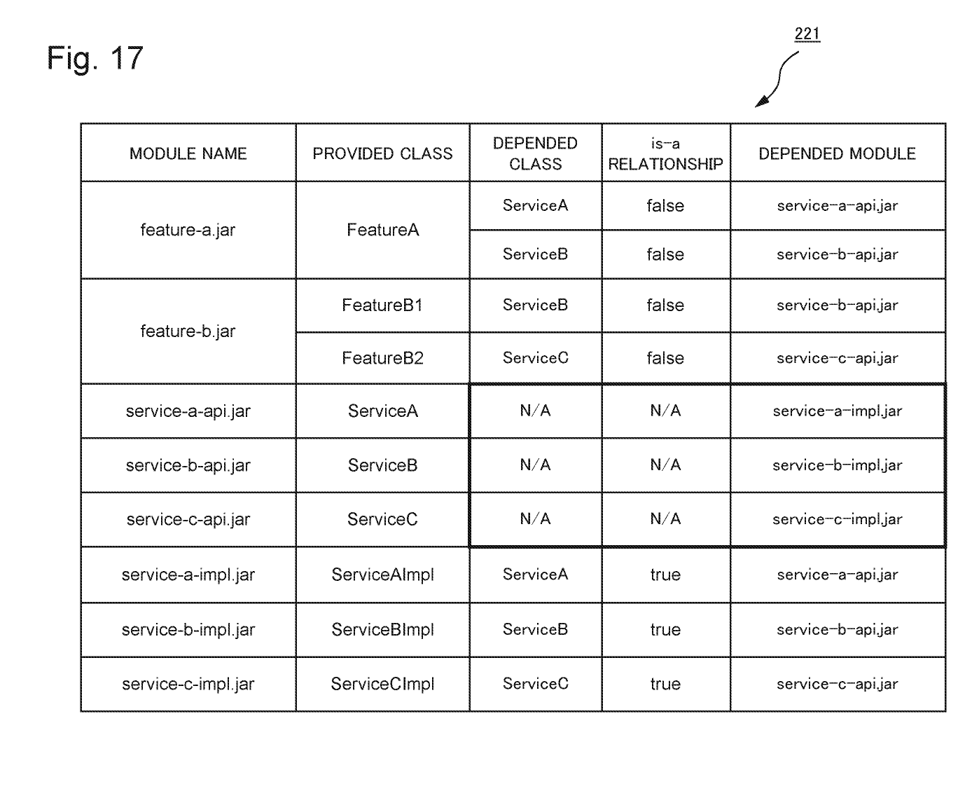

At the end of the processing operation in the dereference construction unit 215, the graph table in the graph table storage unit 221 is as shown in FIG. 17.

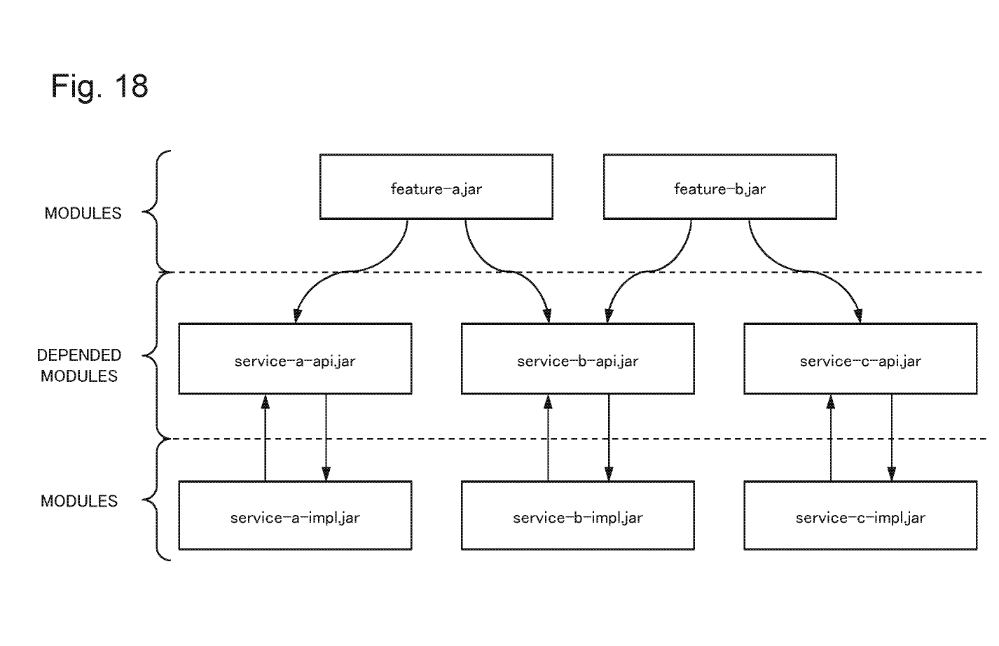

To foster a better understanding, a graph showing the concept of the dependencies between modules, based on the graph table shown in FIG. 17, is illustrated in FIG. 18. The graph illustrated in FIG. 18 is represented using directed edges with module item data represented as archive file names as starting points, and depended module item data as endpoints. This graph shows the state (structure) in which respective modules located on the upper and lower sides of the central, depended module item data (service-a-api.jar, service-b-api.jar, and service-c-api.jar) that are horizontally aligned at the center and operate as interfaces are loosely coupled with each other. This graph not only represents the directed edges pointing to the depended module item data (service-a-api.jar, service-b-api.jar, and service-c-api.jar) but also additionally represents directed edges, in the direction opposite to the former directed edges, on which data indicated by a bold frame portion illustrated in FIG. 17 are reflected.

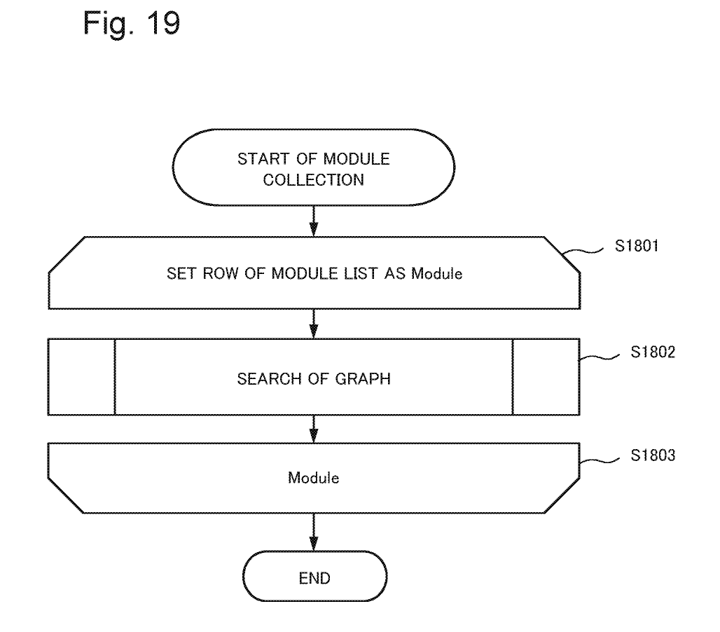

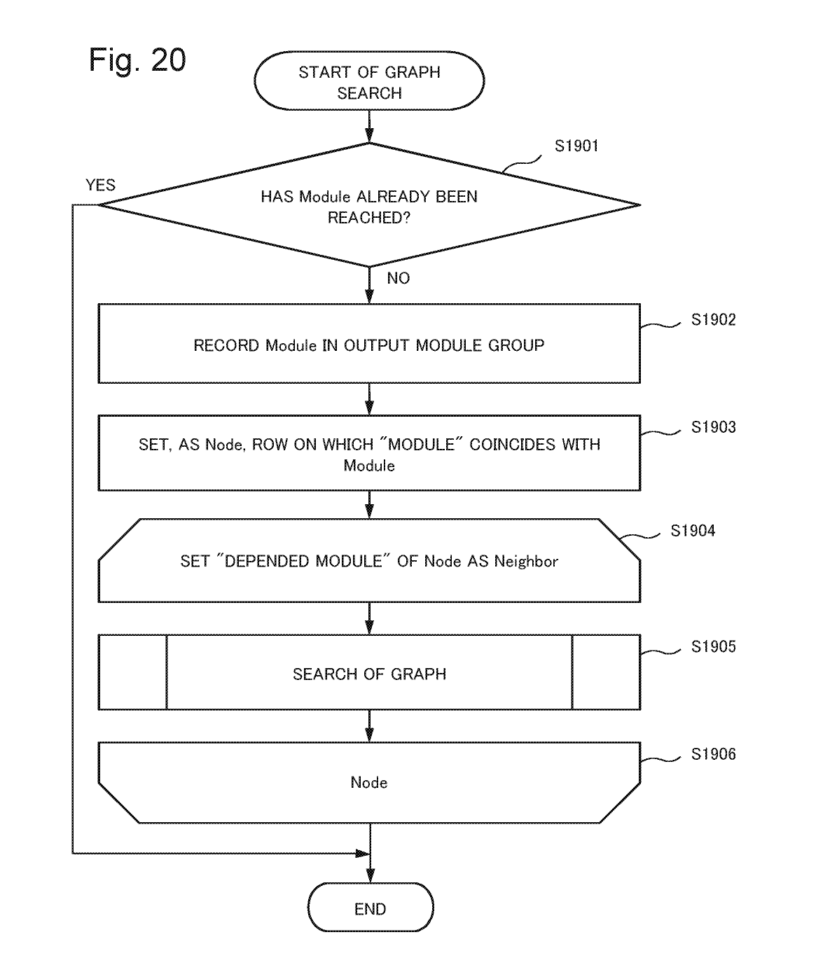

After the end of the processing operation in the dereference construction unit 215, the module collection unit 216 starts its operation. A processing operation in the module collection unit 216 will be descried below with reference to flowcharts illustrated in FIGS. 19 and 20.

In step S1801, the module collection unit 216 sets a module put on the module list within the module list storage unit 220 (see FIG. 6) as “Module.” The loop including steps S1801 through S1803 is iterated while any module in the module list remains to be processed. Although only one module is put on the module list illustrated in FIG. 6, a plurality of modules may be present.

In step S1802, the module collection unit 216 invokes graph search processing for “Module.” This process will be described in more detail later.

Upon the completion of processing of the loop including steps S1801 through S1803, the module collection unit 216 outputs a result to the display device 150 and ends its operation.

The graph search processing in the module collection unit 216 will be described below with reference to FIG. 19.

In step S1901, when a graph search (step S1802) is started, the module collection unit 216 confirms whether a module to be processed has been reached, that is, whether the information of the module has been recorded in the output module group 142. If such recording has been done, the process is ended to end the invoke processing.

If such recording has not been done, in step S1902 the module collection unit 216 records a module in the output module group 142.

In step S1903, the module collection unit 216 obtains a row on which the “module” item coincides with the content of Module from the graph table (see FIG. 17) within the graph table storage unit 221, and sets the obtained row as a Node (variable name) row.

In step S1904, the module collection unit 216 sets the “depended module” held on the Node row as Neighbor (variable name). In other words, the relationship between a given module and a depended module adjacent to the given module is shown. The loop including steps S1904 through S1906 is iterated while any module in Neighbor within the module list remains to be processed.

In step S1905, the module collection unit 216 recursively invokes a graph search for Neighbor. This process will be described in more detail later.

Upon the completion of processing of the loop including steps S1904 through S1906, the module collection unit 216 returns the process to the invoker of the loop processing.

When the processing operation in the module collection unit 216 ends, the operation of the entire apparatus ends.

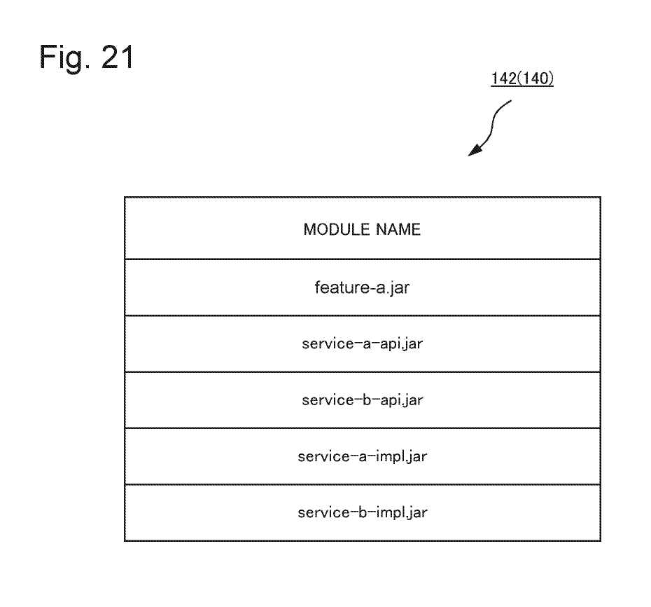

At the end of the processing operation in the module collection unit 216, the content of output modules stored in the output module group 142 is as shown in FIG. 21. These output modules form a module group necessary to operate feature-a.jar.

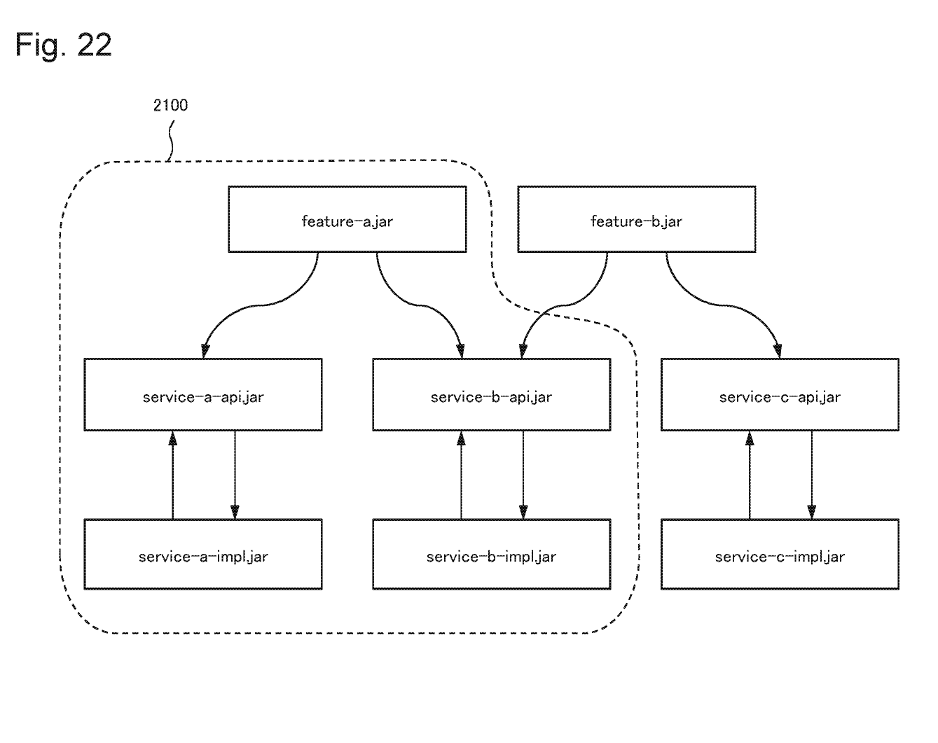

To foster a better understanding, a graph representing the dependencies between modules, based on the output module group shown in FIG. 21, is illustrated in FIG. 22. The graph illustrated in FIG. 22 shows the state in which the module group (see FIG. 21) obtained as a result of collection by the module collection unit 216 out of the graph of the dependencies between modules illustrated in FIG. 18 is surrounded by a dashed border 2100. Referring to FIG. 22, modules necessary for the operation of feature-a.jar fall within the dashed border 2100 and modules necessary for the operation of only feature-b.jar fall outside the dashed border 2100.

### Advantageous Effects of First Exemplary Embodiment of Present Invention

According to the first exemplary embodiment of the present invention, it is possible to analyze software itself to configure software, equipped with functions required by the user, within the analyzed software.

This can be achieved because in the present exemplary embodiment, a subset of modules for configuring reduced-model software having only functions desired to be used is extracted from a set of modules for implementing all functions of a certain piece of software, to automatically configure the reduced-model software. More specifically, only modules corresponding to functions required by the user are output to the display device 150 to enable the user to select functions and corresponding modules while prohibiting, in principle, the user from browsing a complicated internal structure forming the software. The software automatic configuration unit 200 traces a digraph representing the dependencies between modules, using modules for directly implementing functions desired by the user as starting points, to extract modules for configuring reduced-model software. Further, for modules in which interfaces and implementation are separated from each other, the software automatic configuration unit 200 reconstructs a graph representing the dependencies based on the implemented interfaces so that the implementations can be appropriately reached as well.

According to the present exemplary embodiment, even an end user who is unfamiliar with the internal structure of software can customize the configuration of the software. This is because an appropriate configuration can be provided by automatically analyzing the dependencies between modules which constitute software.

According to the present exemplary embodiment, a minimum required configuration free from unnecessary functions can be constructed automatically. This can be achieved because modules are collected in accordance with the analyzed dependencies, so that auxiliary information is unnecessary and a mixture of unnecessary modules is prevented.

According to the present exemplary embodiment, even for software having a loosely-coupled configuration that uses interfaces, implementations required in execution can be appropriately collected. In other words, even for modules in which interfaces and their implementations are separated from each other, their implementation configuration can be appropriately reached. This is because dependencies are reconstructed based on the is-a relationship in consideration of the type of dependency and modules are collected using the reconstructed dependencies.

### Second Exemplary Embodiment

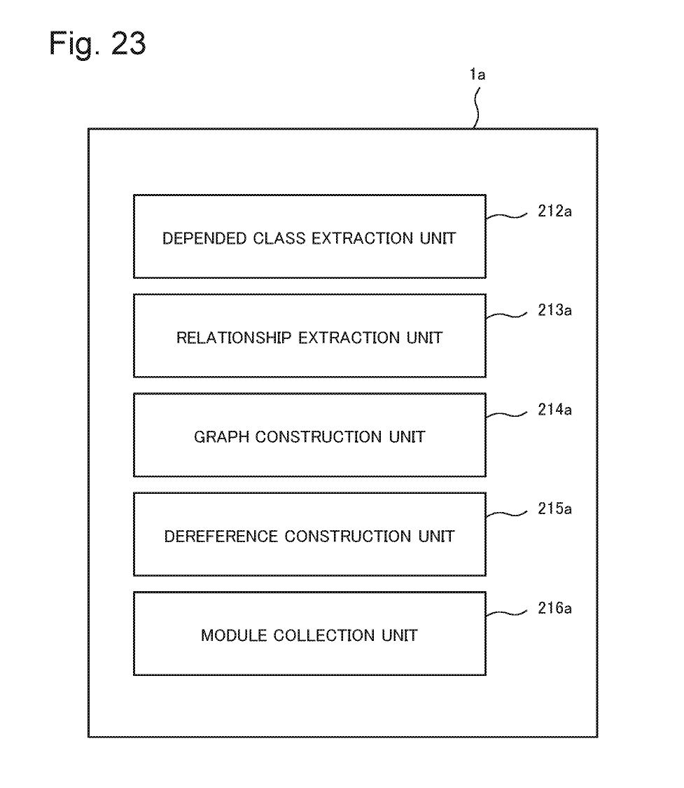

A software automatic configuration apparatus la according to a second exemplary embodiment of the present invention will be described below with reference to FIG. 23. The software automatic configuration apparatus la includes a depended class extraction unit 212a, a relationship extraction unit 213a, a graph construction unit 214a, a dereference construction unit 215a, and a module collection unit 216a, as illustrated in FIG. 23.

The depended class extraction unit 212a extracts a depended class from at least two classes belonging to a module included in a software program.

The relationship extraction unit 213a extracts a provided class on which the depended class depends.

The graph construction unit 214a constructs a path of a graph with the module as its vertex, based on the relationship defined from the provided class to the depended class.

The dereference construction unit 215a traces the path of the graph in the opposite direction to add the path in the opposite direction to the graph.

The module collection unit 216a traces the path of the graph added with the path in the opposite direction, using the module as a starting point, to collect a reachable module different from the module.

According to the second exemplary embodiment, it is possible to analyze software itself to configure software, equipped with functions required by the user, within the analyzed software.

### (Modification)

A Modification to each exemplary embodiment of the present invention will be described below. For DI (Dependency Injection) containers or the like, interfaces and their implementations are often defined in an external file such as an XML (Extensible Markup Language) document. In this case, in other exemplary embodiments of the present invention, a device is created by replacing the depended class extraction unit 212 with processing for analyzing the XML document. Software produced based on service-oriented design permits access exclusively to services published using XML documents or the like and therefore does not require class analysis. In other words, dependencies can be constructed only by analyzing XML documents.

As an advantageous effect of the Modification to each exemplary embodiment of the present invention, software can be automatically configured irrespective of the implementation language and platform. This can be achieved because only general-purpose XML files are analyzed without analyzing binary files.

### (Information Processing Apparatus)

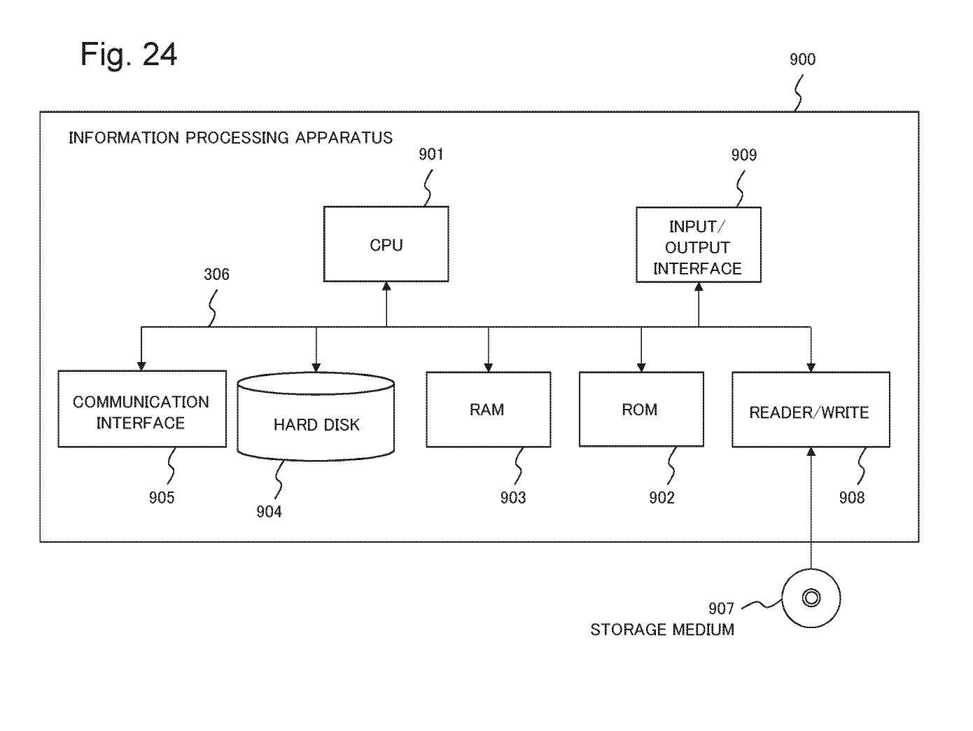

FIG. 24 illustrates, by way of example, a configuration of an information processing apparatus 900 (computer) which can implement an apparatus relevant to an exemplary embodiment of the present invention. In other words, FIG. 24 illustrates a configuration of a computer (information processing apparatus) capable of implementing the apparatus such as illustrated in FIGS. 1,2 and 23, representing a hardware environment where the individual functions in the above-described exemplary embodiments can be implemented.

The information processing apparatus 900 illustrated in FIG. 24 includes the following as components:

CPU 901 (Central_Processing_Unit);

ROM 902 (Read_Only_Memory);

RAM 903 (Random_Access_Memory);

Hard disk 904 (storage device);

Communication interface to an external device 905 (Interface: hereinafter called “I/F”);

Reader/writer 908 capable of reading and writing data stored in a storage medium 907 such as CD-ROM (Compact_Disc_Read_Only_Memory); and

Input/output interface 909.

The information processing apparatus 900 is a general computer where these components are connected via a bus 906 (communication line).

The present invention explained with the above-described exemplary embodiments as examples is accomplished by providing the information processing apparatus 900 illustrated in FIG. 24 with a computer program which is capable of implementing the functions illustrated in the block diagrams (such as FIGS. 1,2 and 23) or the flowcharts (such as FIGS. 5, 7, 9, 11, 13, 16, 19 and 20) referenced in the explanation of these embodiments, and then by reading the computer program into the CPU 901 in such hardware, interpreting it, and executing it. The computer program provided to the apparatus can be stored in a volatile readable and writable storage memory (RAM 903) or in a non-volatile storage device such as the hard disk 904.

### INDUSTRIAL APPLICABILITY

The software automatic configuration apparatus according to each exemplary embodiment of the present invention can be used to implement the profile functions of Java EE. When a lineup of certain software products is supplied upon addition or limitation of functions from low-cost to high-performance models, these products can be configured automatically. In addition, when only a specific function of a certain piece of software is desired to be used with limited machine resources, the certain piece of software can be reduced in weight and executed under such a limited environment.

The previous description of exemplary embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents. Further, it is noted that the inventor's intent is to retain all equivalents of the claimed invention even if the claims are amended during prosecution.

### Reference Signs List

1 software automatic configuration apparatus
1a software automatic configuration apparatus
100 information processing apparatus
110 CPU
120 storage device
130 input device
140 permanent storage device
141 input module group
142 output module group
150 display device
200 software automatic configuration unit
210 starting unit
211 provided class extraction unit
212 depended class extraction unit
212a depended class extraction unit
213 relationship extraction unit
213a relationship extraction unit
214 graph construction unit
214a graph construction unit
215 dereference construction unit
215a dereference construction unit
216 module collection unit
216a module collection unit
220 module list storage unit
221 graph table storage unit
2100 dashed border

We claim:

1. A software automatic configuration apparatus comprising:
a memory storing instructions; and
at least one processor configured to process the instructions to:
extract a depended class from at least two classes belonging to a module comprised in a software program;
extract a provided class on which the depended class has a dependency;
construct a path of a graph with the module as a vertex, based on a relationship defined from the provided class to the depended class;
trace the path of the graph in an opposite direction to add a path in the opposite direction to the graph; and
trace the path of the graph added with the path in the opposite direction, using the module as a starting point, to collect a reachable module different from the module.

2. The software automatic configuration apparatus according to claim 1, wherein the dependency comprises an inheritance relationship.

3. The software automatic configuration apparatus according to claim 1, the processor further configured to
accept a function that a user wants to use, among a plurality of functions comprised in the software program.

4. The software automatic configuration apparatus according to claim 2, the processor further configured to
accept a function that a user wants to use, among a plurality of functions comprised in the software program.

5. The software automatic configuration apparatus according to claim 1, the processor further configured to:
store an input module group comprised in the software program; and
obtain the stored input module group and extract at least one provided class of the provided class belonging to each module of the input module group.

6. The software automatic configuration apparatus according to claim 2, the processor further configured to:
store an input module group comprised in the software program; and
obtain the stored input module group and extract at least one provided class of the provided class belonging to each module of the input module group.

7. The software automatic configuration apparatus according to claim 3, the processor further configured to:
store an input module group comprised in the software program; and
obtain the stored input module group and extract at least one provided class of the provided class belonging to each module of the input module group.

8. The software automatic configuration apparatus according to claim 1, wherein the module collected in the tracing the path, is stored as an output module group in the storing.

9. The software automatic configuration apparatus according to claim 2, wherein the module collected in the tracing the path, is stored as an output module group in the storing.

10. The software automatic configuration apparatus according to claim 3, wherein the module collected in the tracing the path, is stored as an output module group in the storing.

11. The software automatic configuration apparatus according to claim 4, wherein the module collected in the tracing the path, is stored as an output module group in the storing.

12. A software automatic configuration method comprising:
extracting a depended class from at least two classes belonging to a module comprised in a software program;
extracting a provided class on which the depended class has a dependency;
constructing a path of a graph with the module as a vertex, based on a relationship defined from the provided class to the depended class;
tracing the path of the graph in an opposite direction to add a path in the opposite direction to the graph; and
tracing the path of the graph added with the path in the opposite direction, using the module as a starting point, to collect a reachable module different from the module.

13. The software automatic configuration method according to claim 12, further comprising accepting a function that a user wants to use, among a plurality of functions comprised in the software program.

14. A non-transitory computer-readable recording medium storing a software automatic configuration program for causing a computer to execute the functions of:
extracting a depended class from at least two classes belonging to a module comprised in a software program;
extracting a provided class on which the depended class has a dependency;
constructing a path of a graph with the module as a vertex, based on a relationship defined from the provided class to the depended class;
tracing the path of the graph in an opposite direction to add a path in the opposite direction to the graph; and
tracing the path of the graph added with the path in the opposite direction, using the module as a starting point, to collect a reachable module different from the module.

15. The recording medium according to claim 14, further comprising the function of accepting a function that a user wants to use, among a plurality of functions comprised in the software program.

16. A software automatic configuration apparatus comprising:
depended class extraction means for extracting a depended class from at least two classes belonging to a module comprised in a software program;
relationship extraction means for extracting a provided class on which the depended class has a dependency;
graph construction means for constructing a path of a graph with the module as a vertex, based on a relationship defined from the provided class to the depended class;
dereference construction means for tracing the path of the graph in an opposite direction to add a path in the opposite direction to the graph; and
module collection means for tracing the path of the graph added with the path in the opposite direction, using the module as a starting point, to collect a reachable module different from the module.

17. The software automatic configuration apparatus according to claim 16, wherein the dependency comprises an inheritance relationship.
